(19) United States
(12) Patent Application Publication
(10) Pub. No.: US 2004/0054985 A1
(43) Pub. Date: Mar. 18, 2004

(54) Tool and notation for capturing and communicating enterprise and technology structures, processes, strategies, and concepts

(76) Inventor: Marc T. Burton Sewell, Kennesaw, GA (US)

Correspondence Address: Marc T. Sewell, 4050 Palisades Main, Kennesaw, GA, 30144, US

(21) Appl. No.: 10/602,566

(22) Filed: Jun. 24, 2003

Related U.S. Application Data
(60) Provisional application No. 60/391,530, filed on Jun. 25, 2002.

(51) Int. Cl. G06F 9/44; G09G 5/00

(52) U.S. Cl. 717/109; 717/104; 345/763

(57) ABSTRACT

A software design tool and visual language notation comprised of shapes, icons, text, adornments, color, and relationship graphical elements that are combined to generate enterprise drawings and blueprints. The visual language contains the semantic equivalent of nouns, verbs, and adjectives arranged dynamically to produce drawings that communicate in a consistent notation across disciplines. The tool is driven by graphics software and contains novel features including a variable attribute bracket that attaches to and moves with objects, an infinitely variably-shaped fence for grouping objects, the generation of specifications, and a variety of information and object management capacities. This tool and notation is the first uniform visual language for both business and technology, producing enterprise-wide blueprints that encompass all disciplines, concepts, and structures. Previous notations are low-level, targeted primarily to technicians, and do not capture the semantic visualizations needed to communicate to both technical and non-technical professionals, allowing commonly-held expectations.

### CROSS-REFERENCE TO RELATED APPLICATIONS

This application claims the benefit of PPA Serial No. 60/391,530 filed Jun. 25, 2002.

### FEDERALLY SPONSORED RESEARCH

Not Applicable

### SEQUENCE LISTING OR PROGRAM

The object code for this invention is contained on the CD-R (and duplicate copy) in the envelope attached to the last page of this application.

### BACKGROUND OF THE INVENTION

1. Field of the Invention

This invention is a software tool and notation to be used by business planners, consultants, software architects, and others for wide application in business, industry, government, technology, and academia.

2. Background of the Invention

Communication is critical to the success of any enterprise, yet existing methods of communicating strategies, processes, concepts, and structures are cumbersome, verbose, and boring. These consist of text, organizational charts, spreadsheets, clip art, and various boxes with arrows and lines. These methods are applied inconsistently within enterprises and certainly between them. In particular, business leaders complain of their inability to communicate with, and therefore manage, information technology (IT) personnel and projects. Frequently, the IT systems that are developed fail to meet the expectations of management and users.

Modeling techniques such as IDEFx, interaction diagrams, and UML have been applied to business modeling and enterprise architecture. While these approaches could be considered graphic and visual, they are certainly not systematic, uniform ways to communicate business concepts. They are not visual languages. The notation contained in this invention is a visual language that uses the tool to combine shape, icon, text, adornments, relationship graphical elements, and color to create true semantic, visual elements including nouns, verbs, and modifiers. The prior art does not constitute true visual language and does not have the function of the present invention.

The construction industry has a visual language that this tool and notation emulates. Architectural building plans visually depict objectives, structures, elements, and attributes using shapes, icons, adornments, relationships, and text. These are presented in various views and levels of detail to give owners sufficient information to quickly and accurately verify that the design is what they desire and to give builders sufficient information to build and manage the construction process. This approach can be considered the visual language for construction.

The tool and notation being described in this application provides a visual language and blueprints for all enterprises. It is used by managers, planners, consultants, and strategists to “design” their enterprises. IT professionals will also use the tool and notation to design technology. Significantly, both technical and business professionals will use the same tool and notation, bridging the communication gulf that now exists. Business and other non-technical people will be able to validate and manage technology plans and projects just as a homeowner can validate the blueprints for their new home, without having to understand the technical aspects of the building process. Likewise, IT professionals people will see where their plans fit into the plans of the overall enterprise because the technology plans are embedded in the larger set of plans for the entire enterprise.

It is estimated that up to 40% of all software development projects undertaken by Fortune 500 companies are cancelled completely before completion. Of those completed, only 23.6% are completed on time and within budget (The Standish Group). This state of affairs is commonly referred to as “The Software Crisis.” It is not caused by technological challenges or risks but, rather, because of a failure to communicate effectively. IT professionals and non-technical professionals do not have a shared notation or shared blueprints, such as those found in the construction industry. The basic dictum, “Design it first, and then carefully build it,” is frequently ignored because there are no unified building plans for all to see and understand. This tool and notation will enable the design of enterprise-wide plans or blueprints with the power of a true visual language. This is unlike existing code-level, development notations, like UML, that have graphical shapes representing specific elements in a methodology and have only text for the problem domain semantics. The difference between UML (and similar methods) and this invention is analogous to the difference between MS-DOS, with its simple text screens, and Microsoft Windows.

### SUMMARY OF THE INVENTION

This invention is a tool with a notation and document layout created for business and software architects. These “architects” are commonly referred to as planners, designers, strategists, consultants, business process engineers, and analysts, but we refer to them, for simplicity sake, as “architects” because their role is identical to the classic role of architect. We call individual documents “drawings,” and the entire collection of drawings “blueprints.” Design is defined as all aspects of understanding the domain, the problem, and the needs and requirements of the client; designing a solution comprised of strategies, structures, processes, and concepts; preparing drawings and blueprints; and project management of the implementation or operation. Visual definitions, created with the tool using the notation, of the terms “architect,” “design,” “architecture,” and “blueprints” are found in FIGS. 21A and 21B.

The tool and notation provide a visual representation of strategies, structures, concepts, and processes by combining individual elements including shapes, icons, text, adornments, conventions, and color into semantically meaningful objects and relationships. Road signs are an example of a visual language. They, like this tool and notation, communicate powerfully and efficiently by combining shape, color, graphical elements, and text into one visual object.

In the tool and notation, an object is created by combining an icon, a shape, and a title (located at the top of a bracket attached to the shape). These elements represent an object's visual identity and are the equivalent of a noun. Other attributes of an object—adjectives—can be placed in the bracket following the title, or in the form of adornments, color, or text placed on the shape. The adornments can describe and/or limit, and/or represent hierarchy, location, behavior, and responsibilities. In the notation, relationships are depicted as graphical connections between objects and these are equivalent to the verbs “has-owns,” “has-uses,” “is,” “invokes,” and “flow.”

Graphical blueprints are created with the tool and notation. They consist of drawing and specification pages and are used to depict a design and to plan and implement new structures, processes, strategies, and concepts. The blueprints are then used by all involved to validate progress and change. The design and planning process can be circular as new ideas are tried and refined or rejected. Necessary invention takes place and design changes are based on these results. The tool manages these changes and also creates the resulting specifications.

In addition to providing enterprise-wide blueprints, the tool and notation will provide the failure-prone field of software development with a modeling language that communicates clearly to both technical and non-technical professionals—to the client and builders, as it were—and will enable complex technologies to be built more predictably, efficiently, and reliably.

### BRIEF DESCRIPTION OF THE DRAWINGS

FIGS. 1A and 1B—Domain Shapes—The base shapes for the domain objects of the notation.

FIG. 2—Technology Shapes—The base shapes for the technology objects of the notation.

FIG. 3—User Interface Shapes—The base shapes for the user interface objects of the notation.

FIG. 4—Design Notes, Initiative, Issue, Design Points, Rules—The base shapes for the design notes and rules shapes of the notation.

FIG. 5—Collection, Container, Hierarchy—The adornments to shapes for collection hierarchies, object collections, plural, patterns, and object grouping.

FIG. 6—Process Shapes and Adornments—The notation for process objects.

FIG. 7—Initiative Hierarchy Example—The notation for initiative objects.

FIG. 8—Framework, System, Component Example—The notation for framework, system, subsystem, application, package, framework, and component objects.

FIGS. 9A and 9B—Relationships—The notation for relationships.

FIG. 10—Grouping Shape (Fence) Examples—A sample notation group object containing UI objects and bracket text.

FIG. 11—Sample Tool Embodiment—Screen shot of the tool.

FIGS. 12A, 12B and 12C Tool Windows—The anchored windows from FIG. 11.

FIGS. 13A, 13B, 13C, 13D, 13E Sample Activity Drawings—Sample activity drawings using the notation.

FIGS. 14A and 14B—Sample Icons—Sample icons that go inside shapes to create objects.

FIG. 15—Bracket Samples—A sample bracket adornment that goes anywhere along the circumference of a shape. Sample shows placement of component icon.

FIG. 16—Process Model—High level process model for process object specifications.

FIG. 17—Blueprint Drawing Types—Drawing types and labels.

FIG. 18—Release Plan Model—Release plan model for generated project plans.

FIG. 19—Specification Document—Contents of a specification document.

FIG. 20—Emphasis Examples Minor Shading—This example shows six different forms of emphasis for the same attribute.

FIGS. 21A and 21B—Architect, Design, Architecture, and Blueprint Definitions.

FIG. 22—The Tool Defined in the Notation.

### DETAILED DESCRIPTION OF THE INVENTION

In the following description of the invention, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

The present invention is typically implemented using a personal computer. It is envisioned that attached to the personal computer may be a monitor, keyboard, mouse, data storage devices (such as hard disc drives and/or floppy disk drives and/or CD-ROM drives), and a printer.

While the general operation of a graphical design tool or CAD tool is the user software environment for this tool and not part of the invention, the resultant blueprint is unique. The novelty is derived from the notation and extensions to a graphical environment that allow the notation to be implemented. This includes icon selection, a bracket device, a fence grouping device, and access and manipulation of object information.

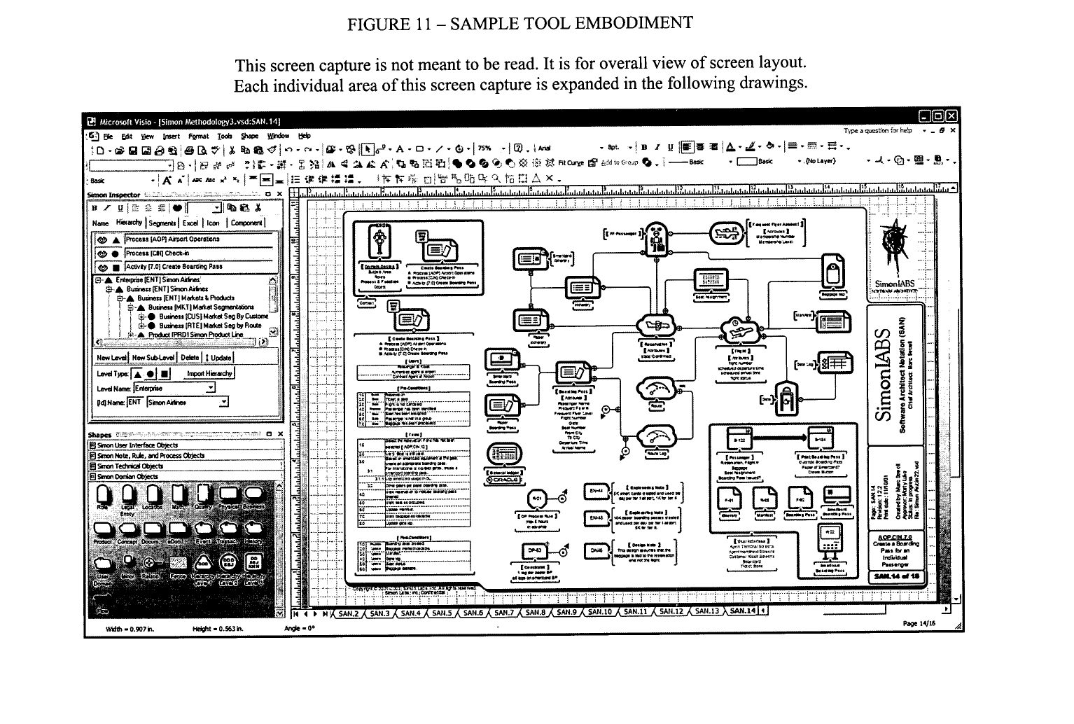

Shapes dragged onto a drawing canvas and double clicked, or using an inspector window to get a specification dialog, are typical behaviors of such tools, like Microsoft Visio (used for this embodiment of the invention and figures) and is one of several possible bases for this invention. See FIG. 11 for an example of the environment.

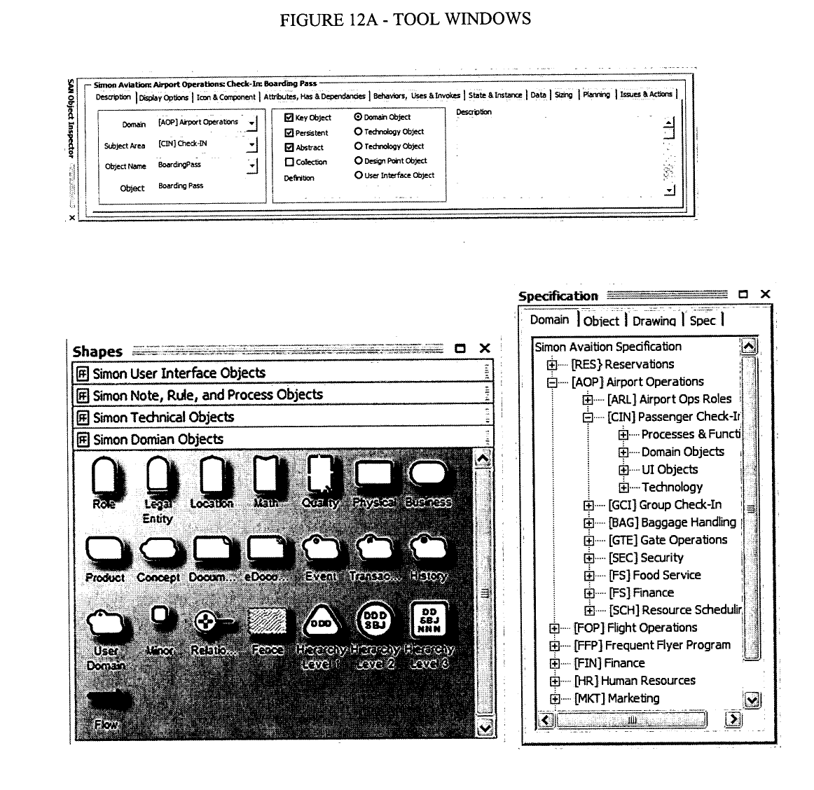

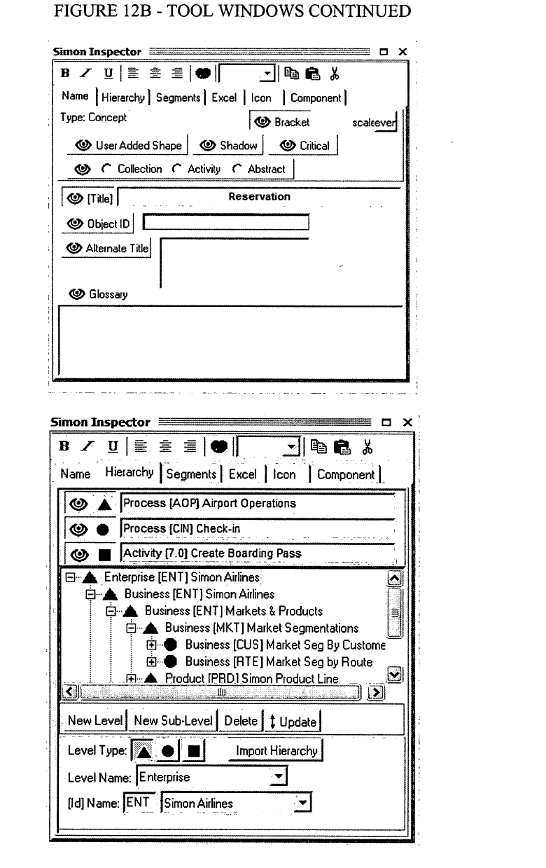

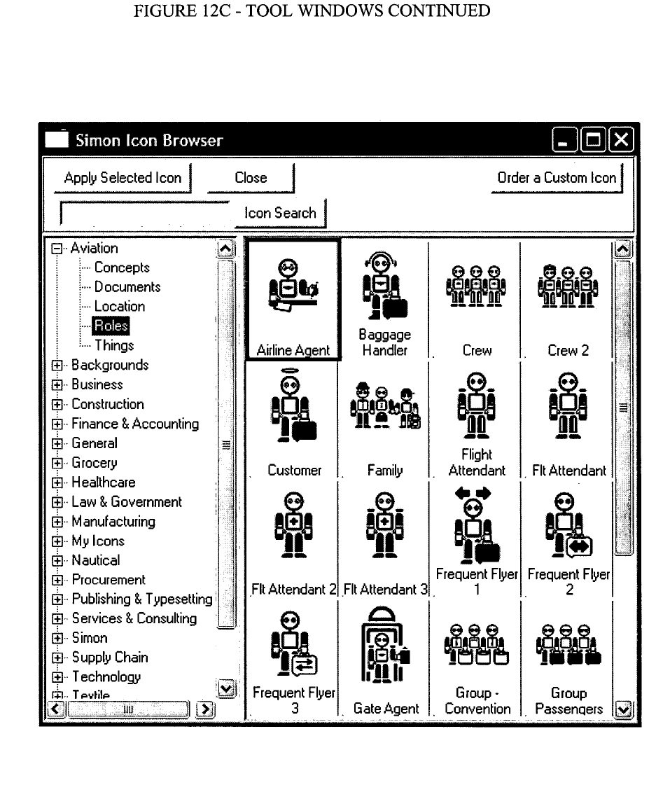

The windows shown in FIGS. 12A, 12B, and 12C (and the programs behind them) are added to the graphical environment to create the disclosed tool. These windows allow for the access and manipulation of objects.

Those skilled in the art will recognize that the environment described is not intended to limit the present invention. Indeed, those skilled in the art will recognize that other alternative hardware and software environments may be used without departing from the scope of the present invention.

The user will start by choosing an existing project, create a new project, create a new drawing, or use a wizard to create a new drawing.

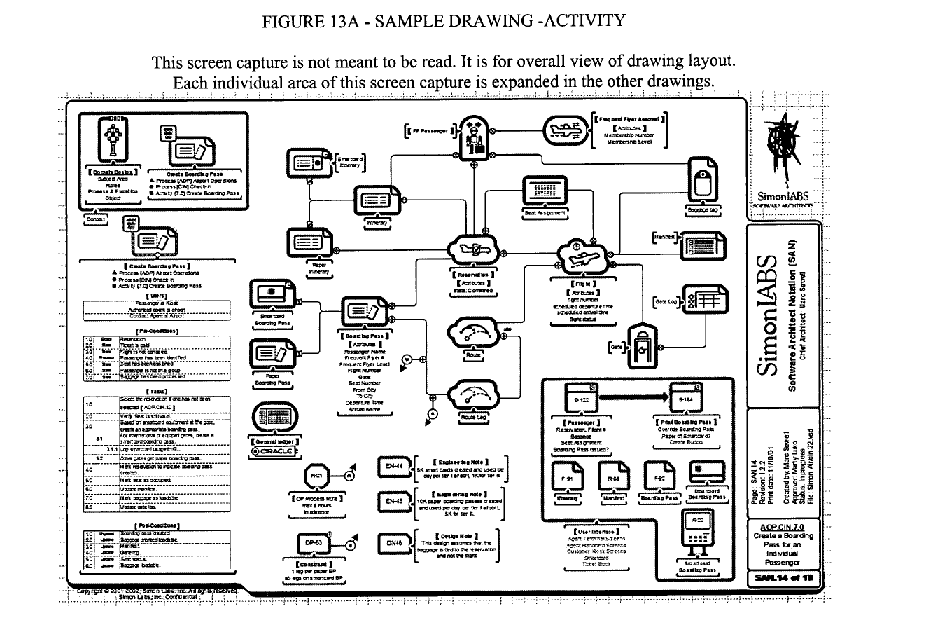

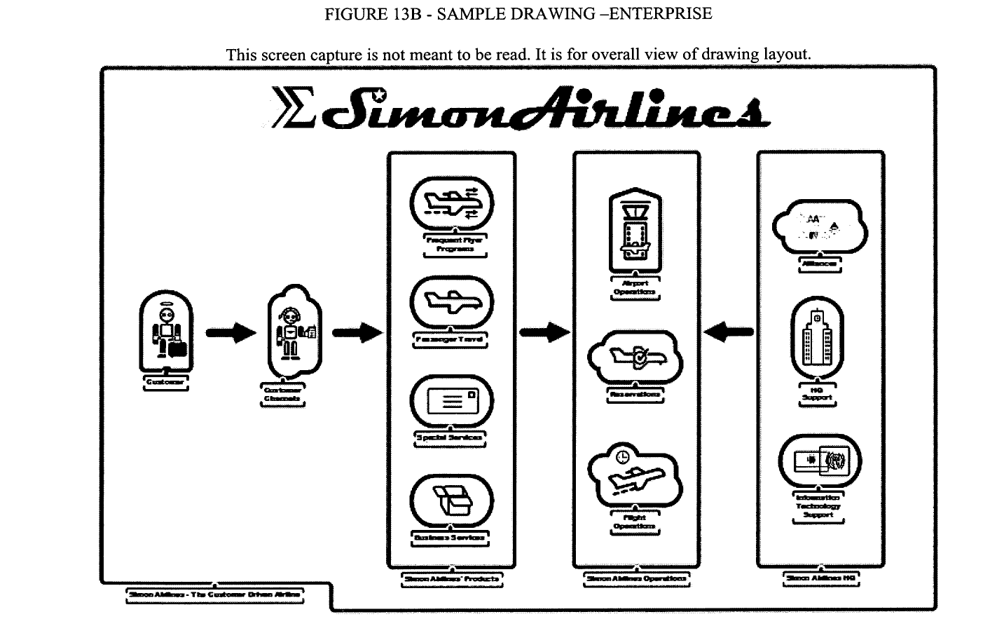

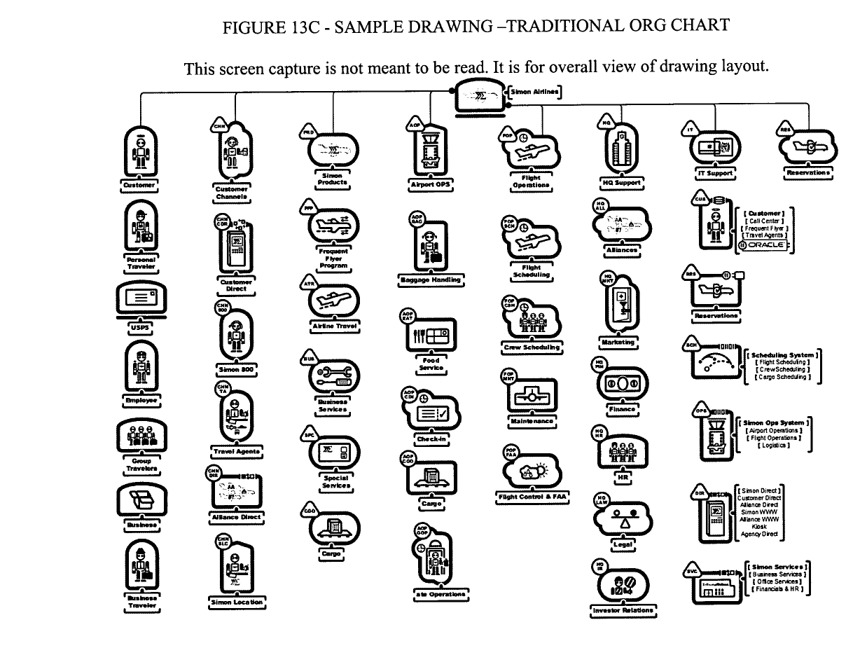

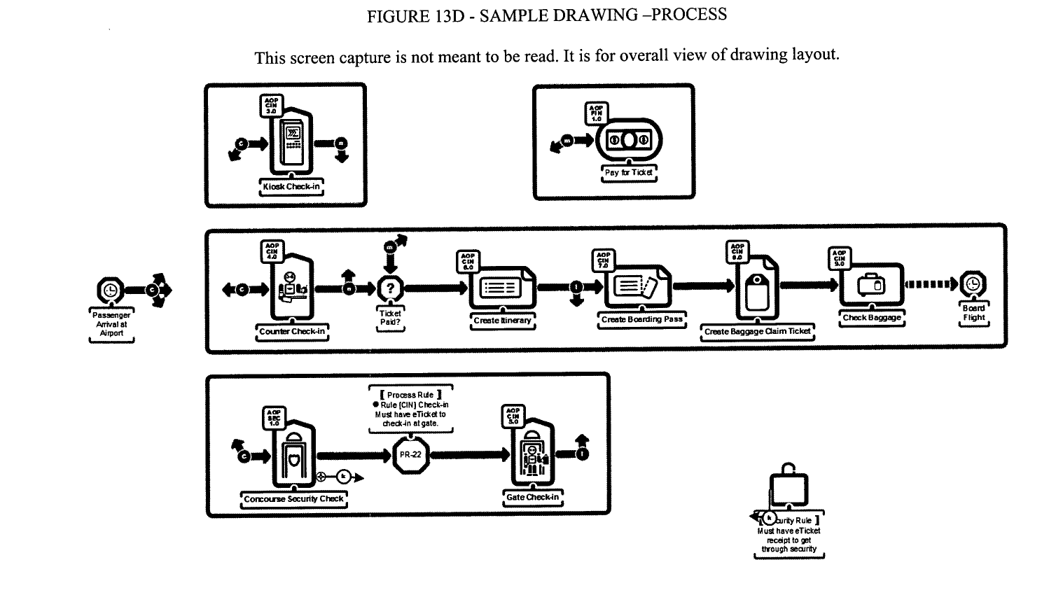

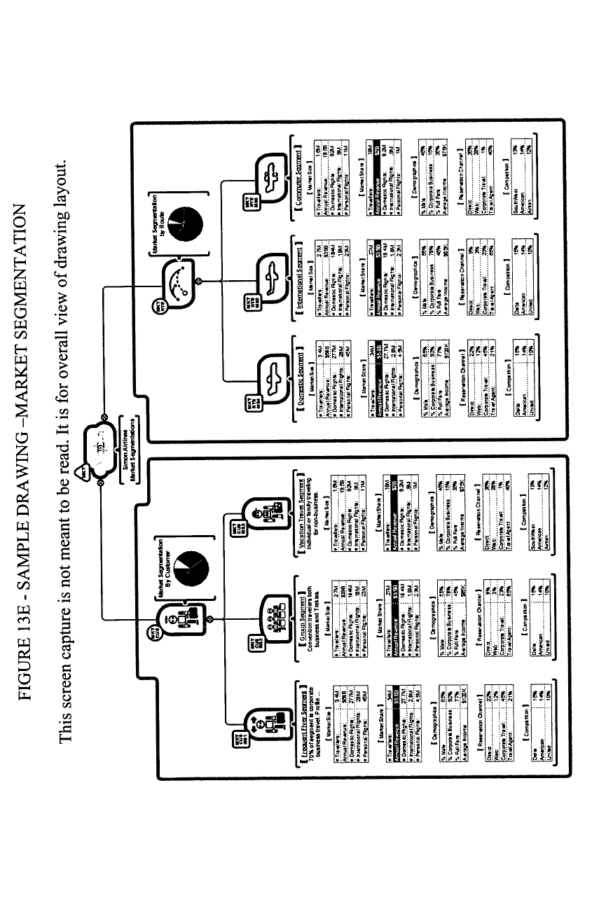

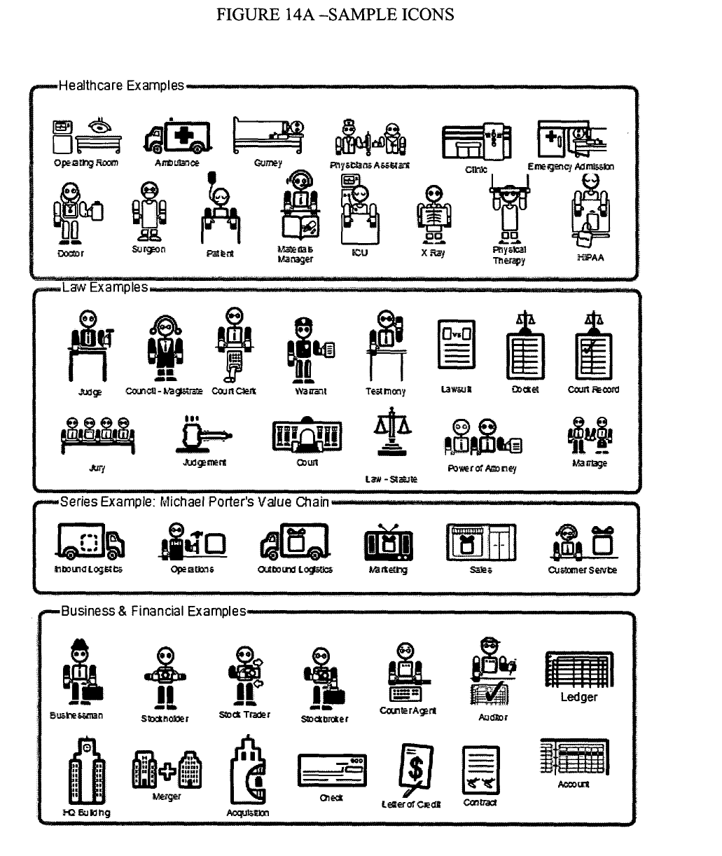

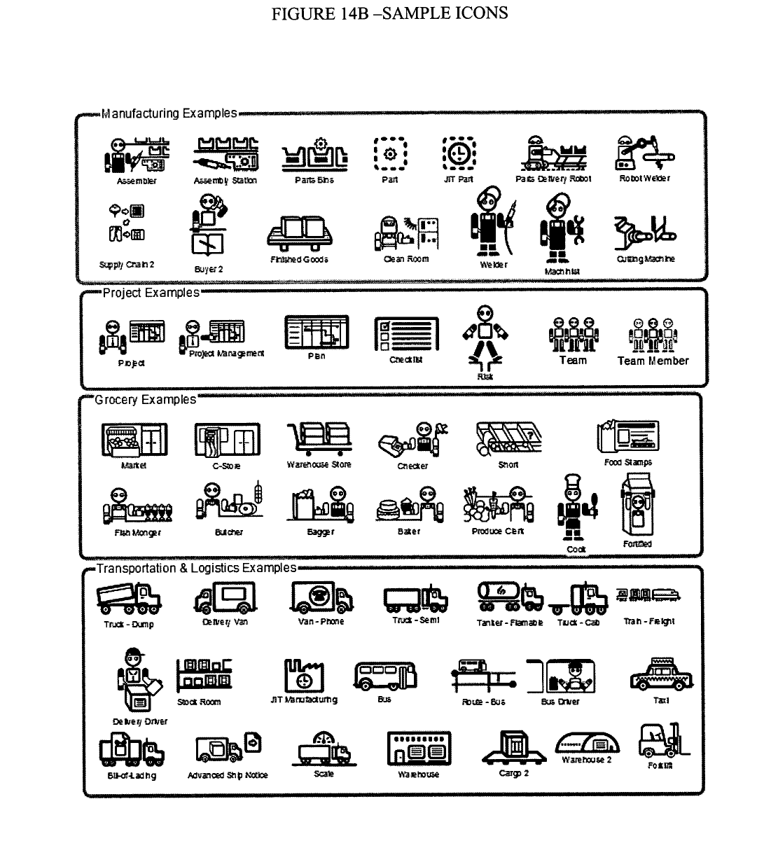

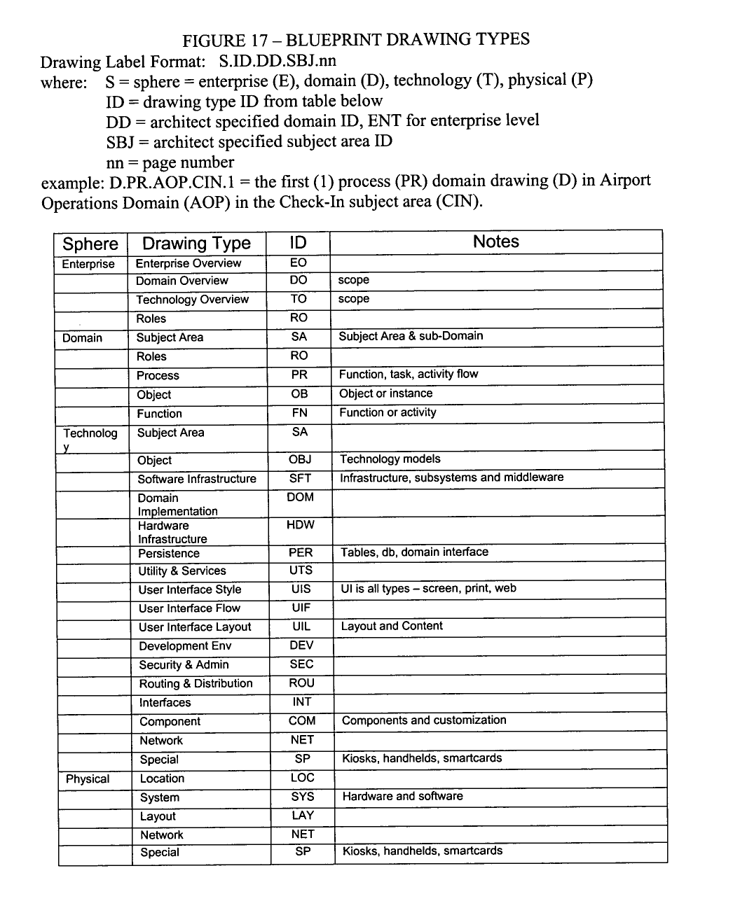

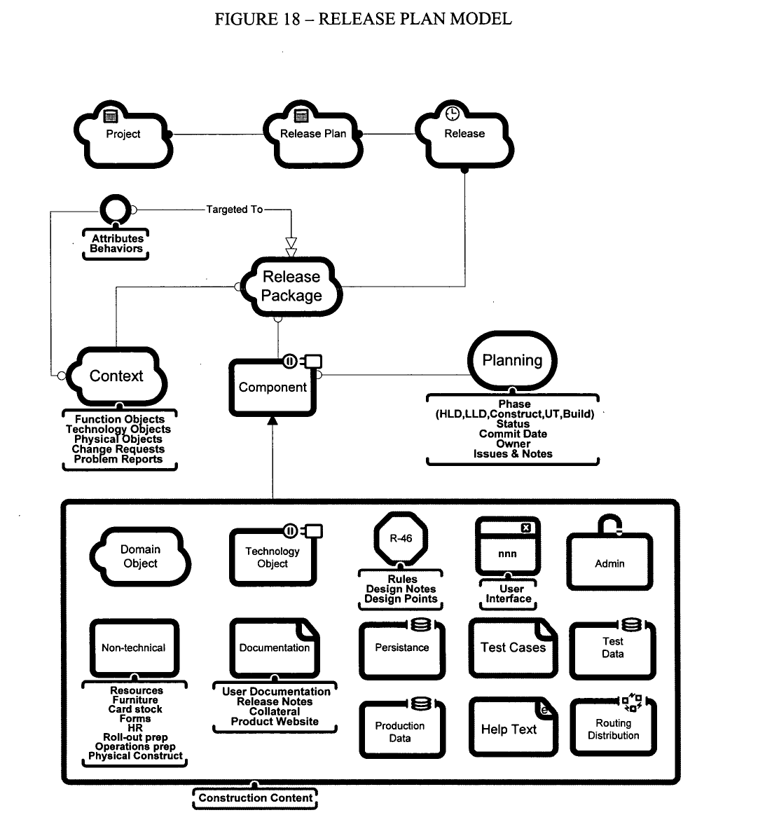

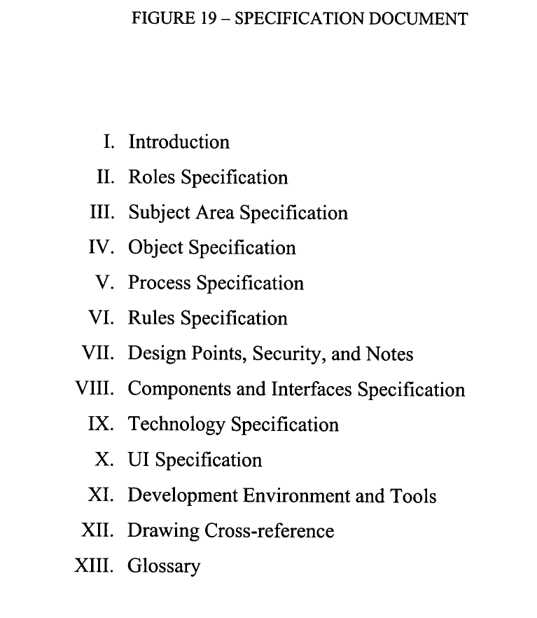

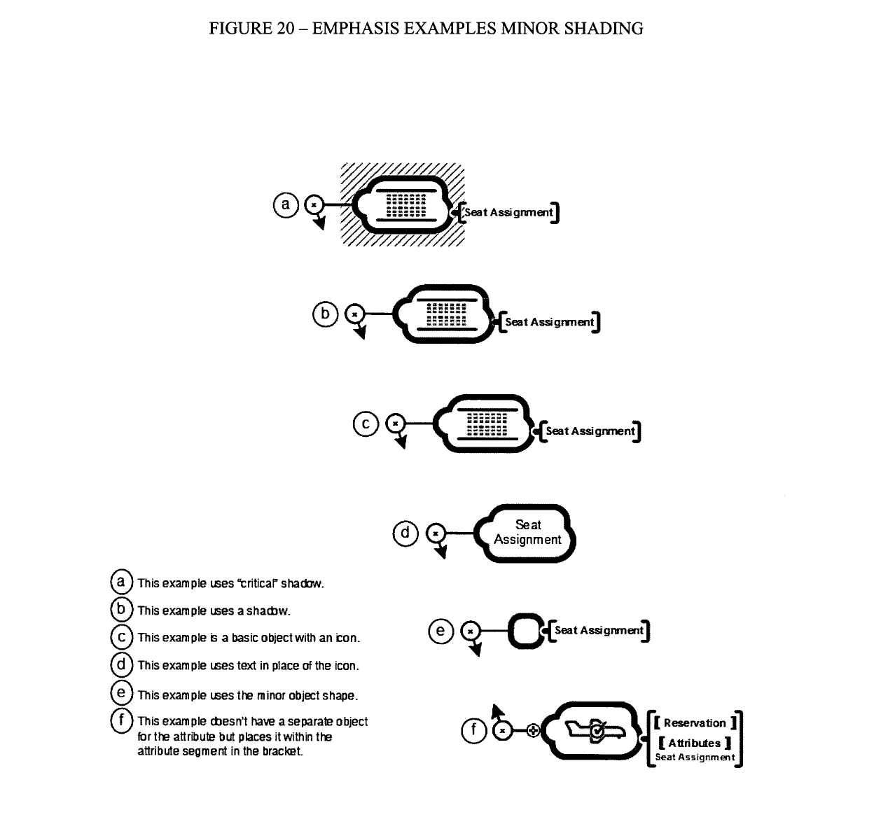

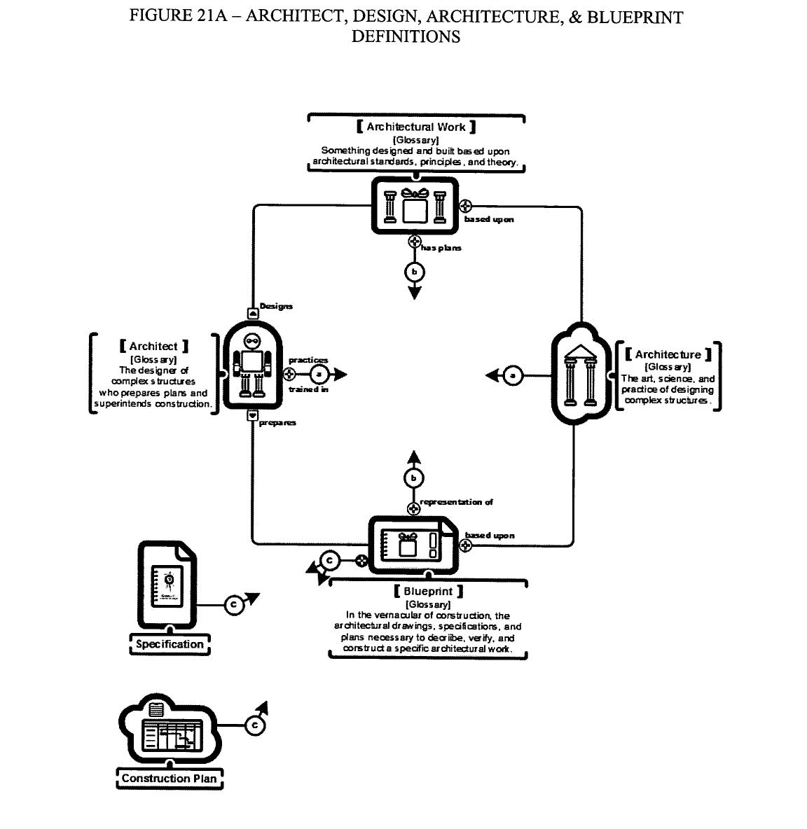

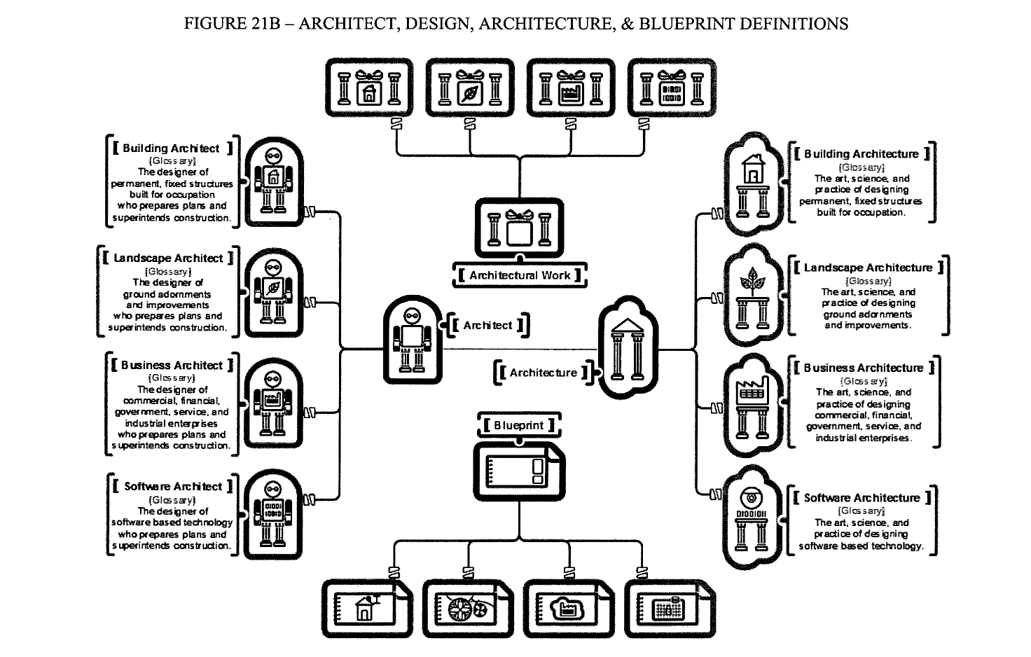

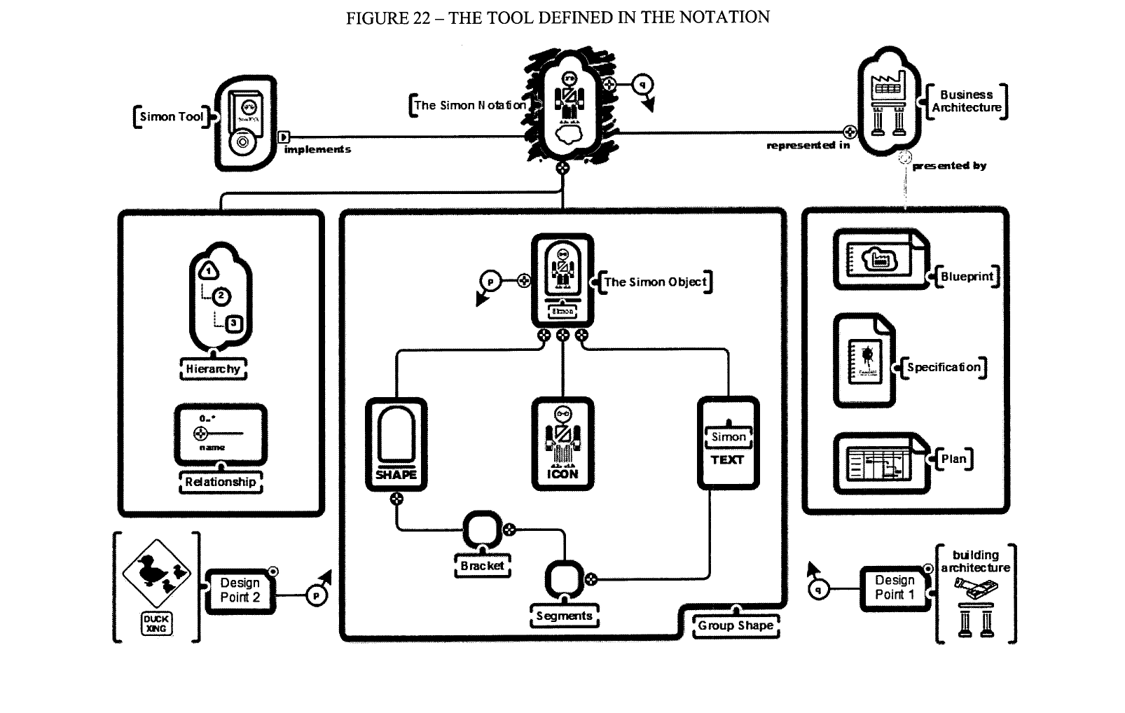

The user will choose a drawing type (listed in FIG. 17) and give a title to the page. FIG. 13A is a sample activity drawing showing the “create a boarding pass” activity in an airline check-in application.

The user will then create a drawing by selecting shapes and placing them on the drawing page. Objects can also be created by selecting an area of the specification in the Specification Window, FIG. 12A, and selecting ADD.

The user will then enter specification information in the Object Inspector, FIG. 12B, or select an existing specification to create a copy of an object.

The user will select an icon for the object shape or specify text for inside the shape, FIG. 12C.

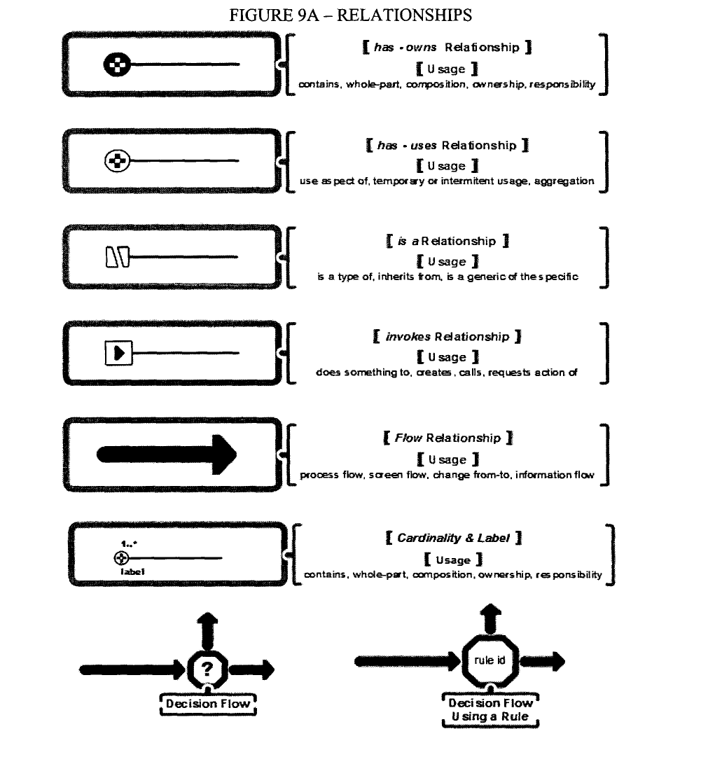

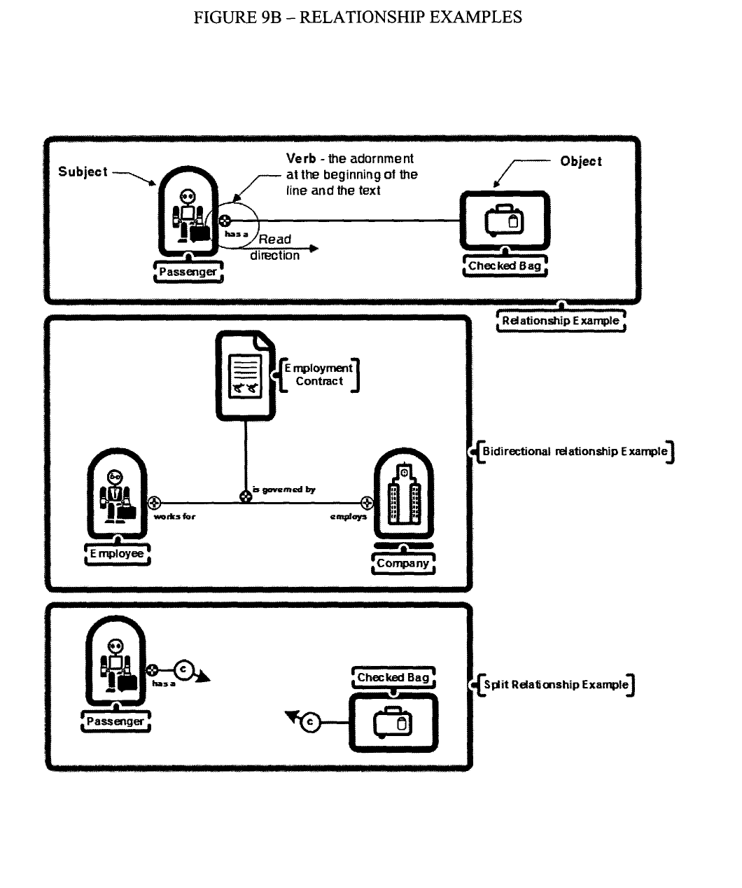

The user will create relationships between the objects using the notation relationships defined in FIG. 9.

The user will arrange objects (shapes), brackets, relationships and groups on the page to best communicate a specific portion of the design.

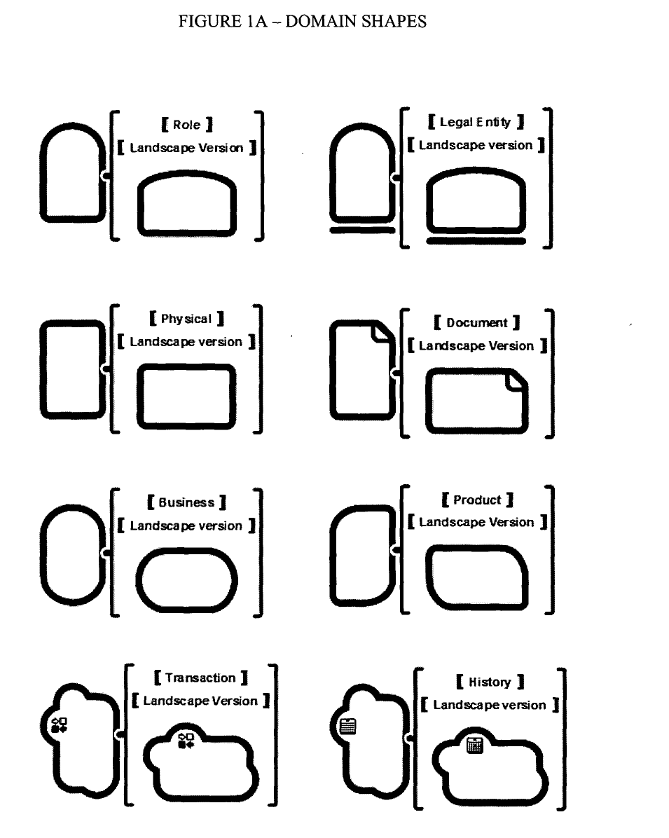

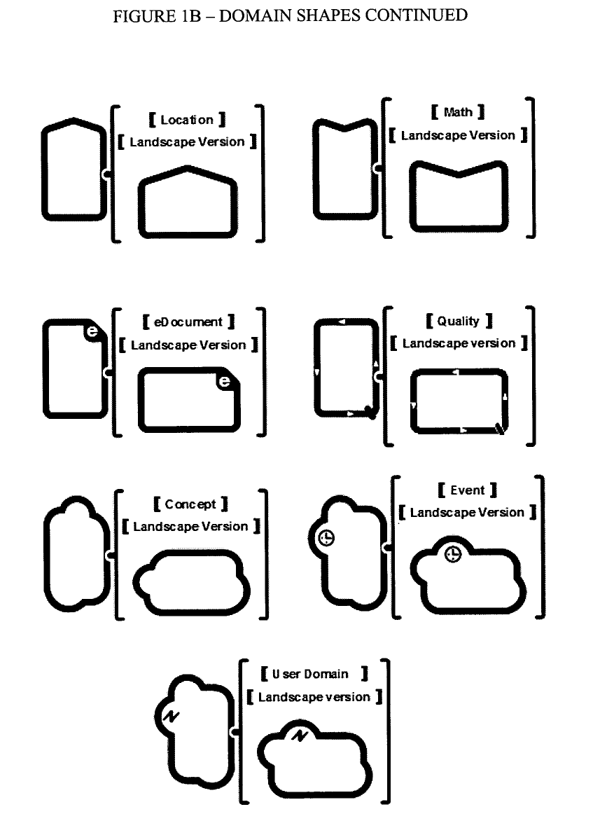

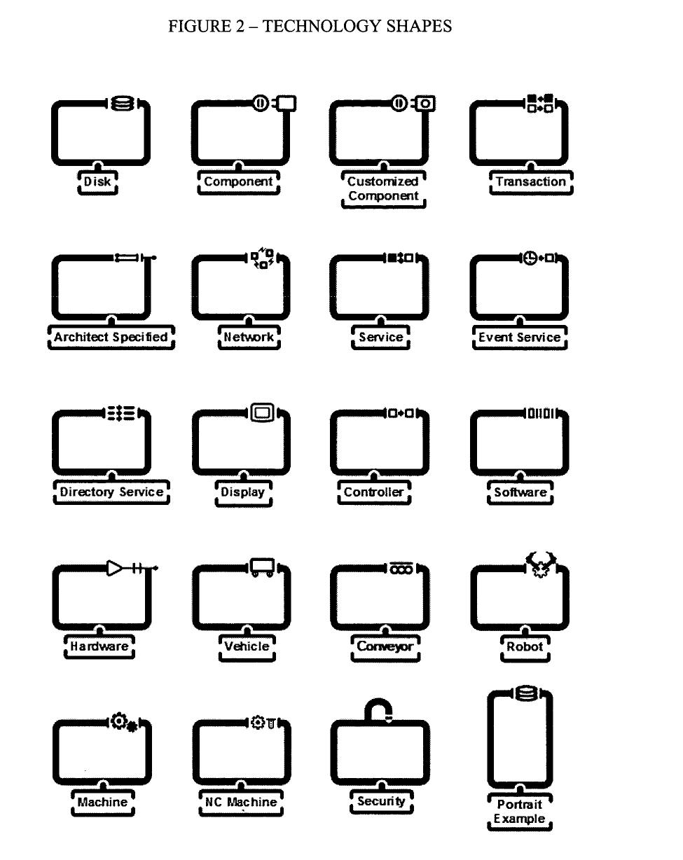

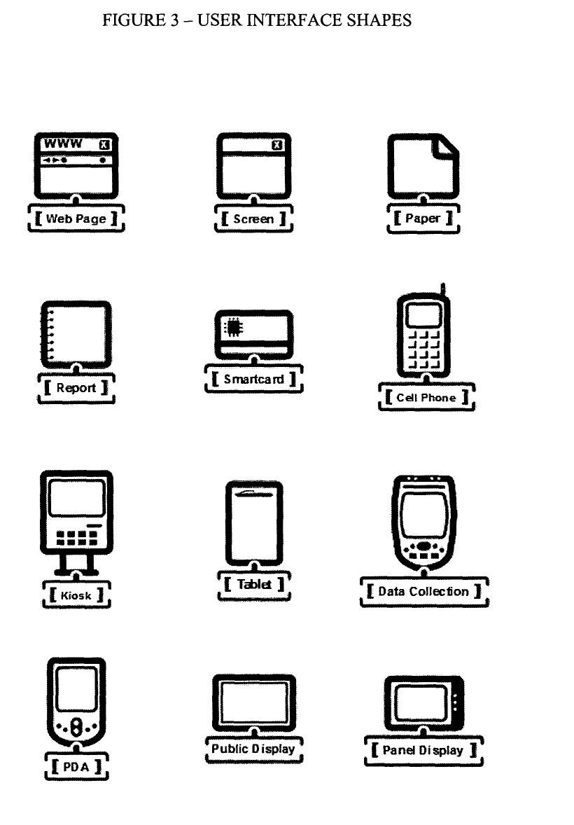

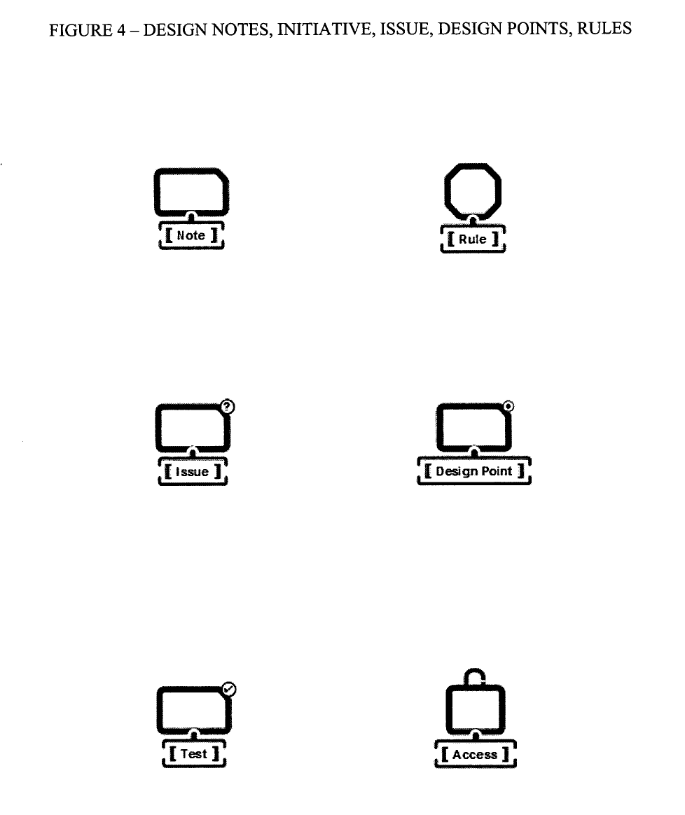

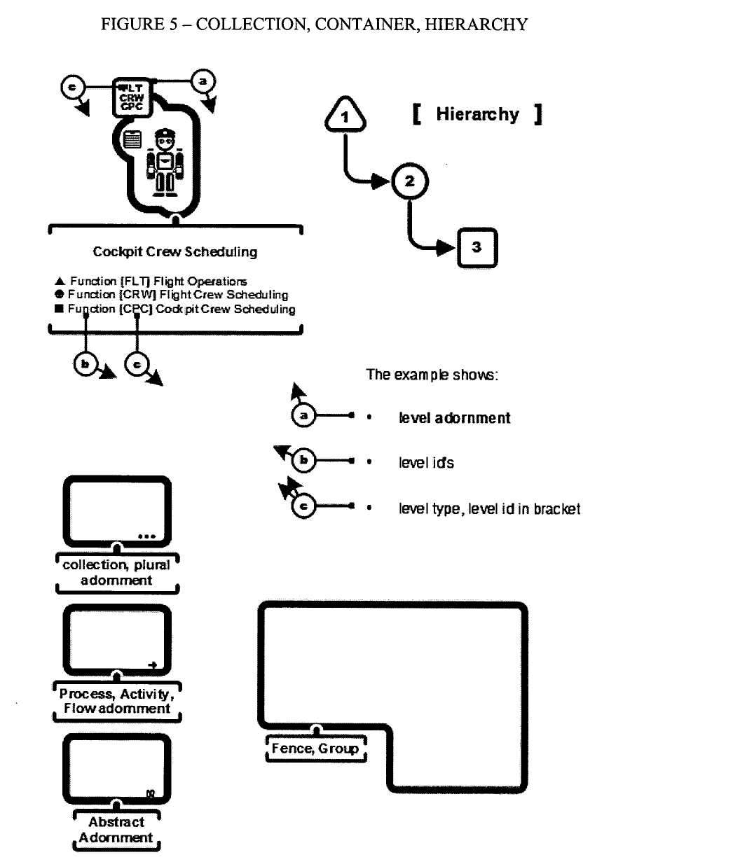

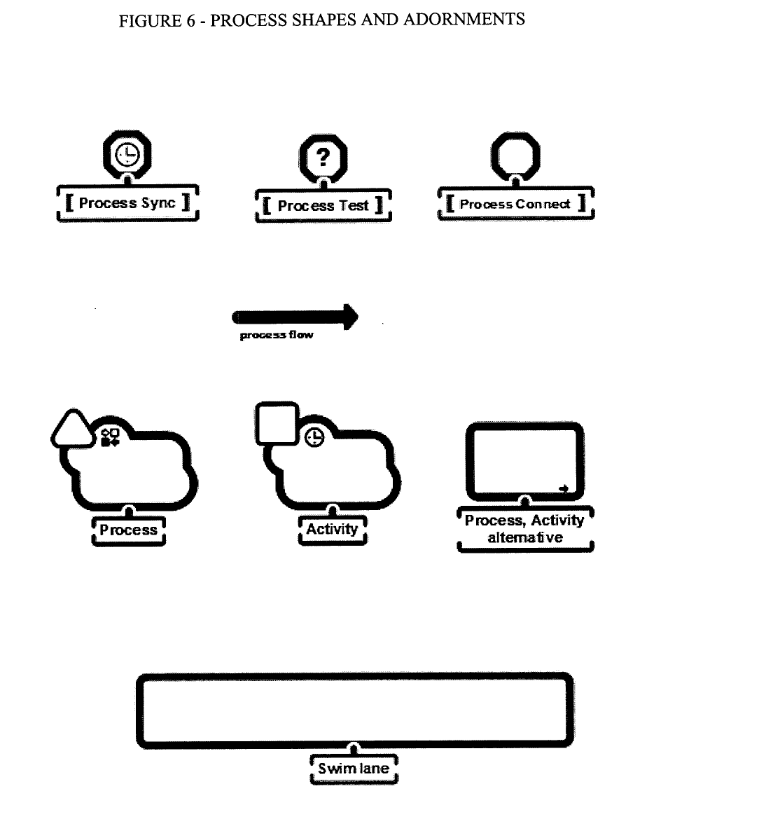

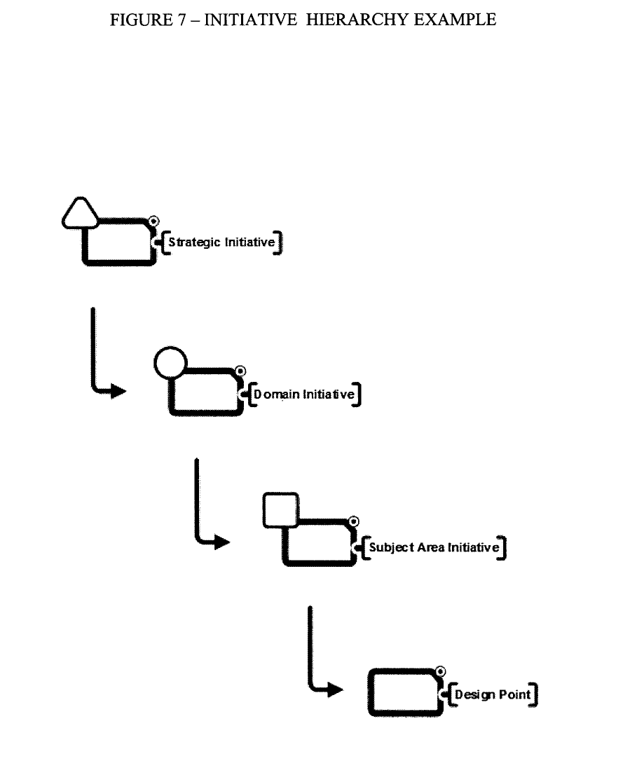

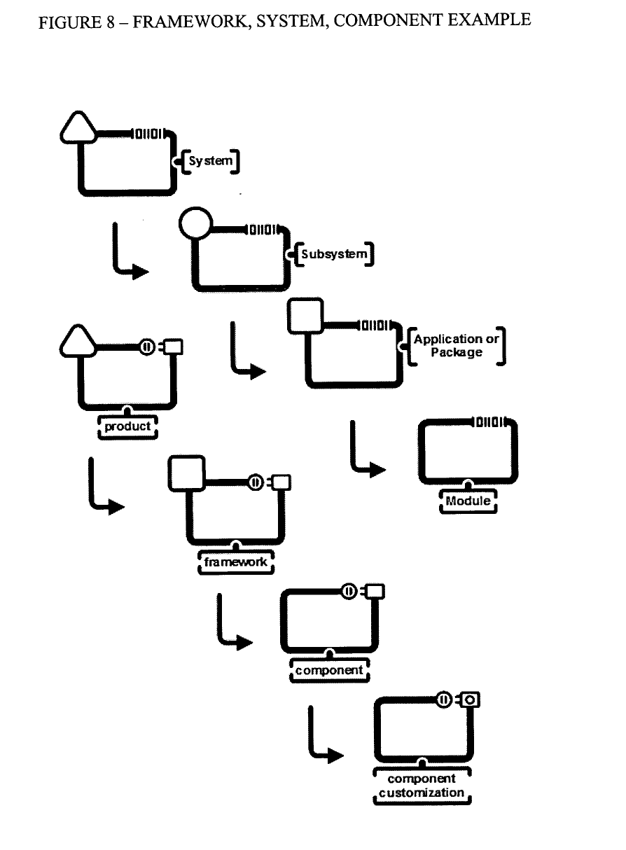

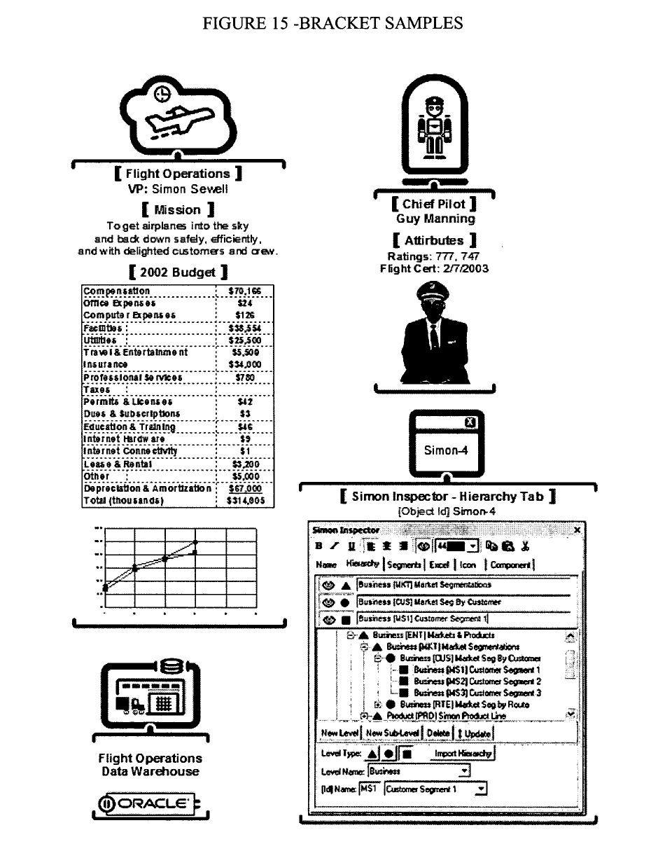

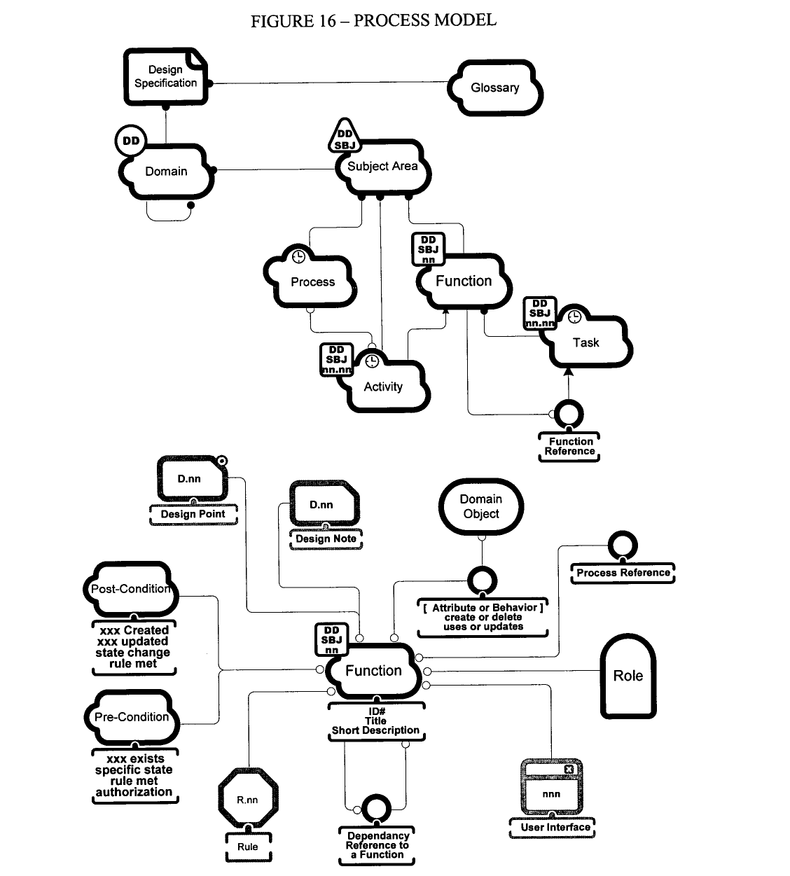

The bracket is a tightly-coupled, subordinate container shape that is attached to one of the notation shapes. It attaches to the parent shape with an attachment point that can be attached at predetermined, appropriate points in the vicinity closest to where the user indicates. The bracket contents are divided into segments of varying type, such as a title, lists, tables, graphics, spreadsheets, adornments, embedded output from external products and adornments, and text. Each segment or portion thereof can be viewed or hidden at user control and the bracket automatically expands and contracts to the size of the visible segments. The bracket contents automatically orient according to where the bracket is attached to the parent shape. The bracket automatically moves and stays in position as the parent shape is moved. The whole bracket, and its contents, can be hidden. The bracket is illustrated in FIG. 15 which shows examples of various segment content types. Many other figures, such as FIG. 1A and FIG. 9 show various placements of the bracket.

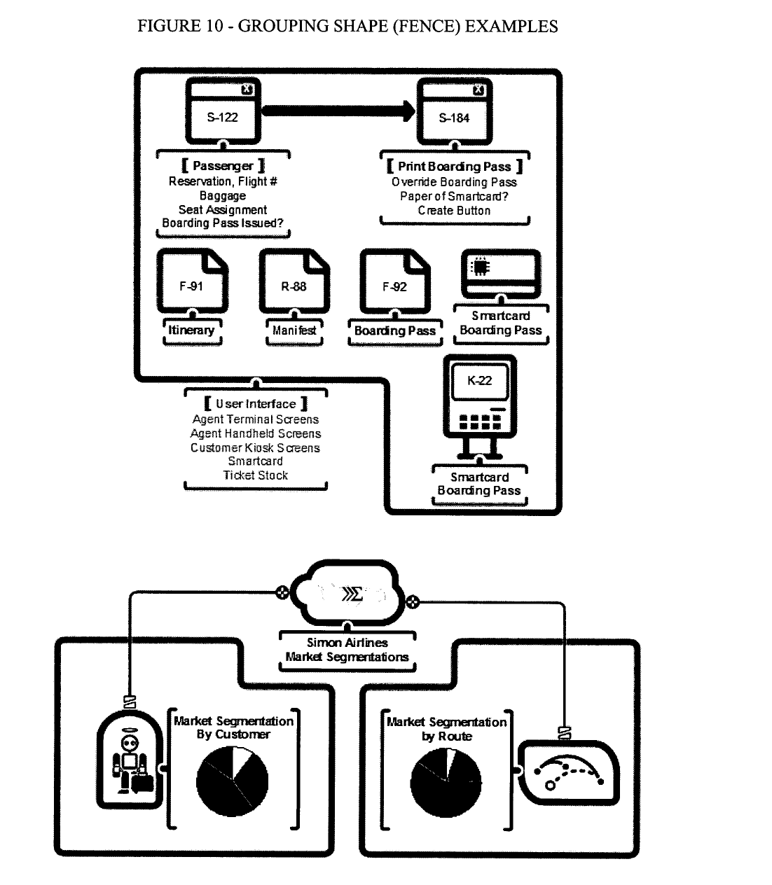

The user can group objects with a fence shape to provide a single identity for the fenced shapes or to provide emphasis or separation for readability. The shape of the fence is infinitely variable by manipulating points on the perimeter of the fence. FIG. 10 shows two examples of fence grouping of shapes and of the perimeter having been manipulated.

Detailed user interface drawings may be done with a user interface stencil and physical drawings will be drawn using a physical component stencil.

When drawing pages are complete, they may be printed and the specification document can be generated and printed.

The current embodiment is written in Borland Delphi as a Microsoft Visio 2002 Add-on and is included on the attached CD-R. The Add-on is placed in the Visio Solutions Directory along with the shape stencils and icon database running on Microsoft Windows XP on any Windows-supported PC.

### CONCLUSION, RAMIFICATIONS, AND SCOPE OF INVENTION

The tool and notation provide a highly flexible, efficient means of producing enterprise-wide maps or blueprints across domains, departments, disciplines, and industries. The use of the tool and notation does not require technical expertise or lengthy training. It will be used by people with differing backgrounds, but the resulting blueprints will be understandable to all who are involved.

While the above description of the tool and notation contains many specificities, these should not be construed as limitations on the scope of the invention, but rather as an exemplification of one preferred embodiment. A visual language can be used to communicate anything in a visual, graphical way and could have applications beyond the generation of enterprise blueprints. Similarly, components of the tool and notation, such as the variable bracket and fence mechanisms, could be used in other graphical applications.

Thousands of icons and a plethora of shapes, graphical elements, and adornments are present in this tool and notation. Additional styles of icons, shapes, relationships and adornments are also a part of this invention and are used for different user populations. For example, Wall Street will have a more serious visual style than a toy store chain. The style used in the drawing section of this application is just one style. Therefore, changes in shape, size, image, or style comprise alternate embodiments and are within the scope of this specific invention.

Accordingly, the scope of the invention should be determined not by the embodiment illustrated, but by the appended claims and their legal equivalents.

What is claimed is:

1. A tool and notation for capturing and communicating, in a graphically visual way, enterprise and technology structures, processes, strategies, and concepts comprising:
(a) a plurality of shapes
(b) a plurality of icons
(c) variable text and fonts
(d) a plurality of adornments and colors
(e) a plurality of relationship graphical elements
whereby blueprints are generated with a consistent notation across enterprise domains and between different enterprises.

2. The tool and notation of claim 1 wherein said icons and/or text can be placed within said shapes, which will then orient to the size and shape of said icon, and which are then named objects, which are semantically equivalent to simple and compound nouns.

3. The objects of claim 2 are modified with said adornments, colors, and text, which are semantically equivalent to adjectives that describe, limit, and/or indicate hierarchy, location, behaviors, and/or responsibilities.

4. The objects of claim 3 wherein said objects are allowed to be presented in graphical or text formats.

5. The objects of claim 3 are linked with said relationship graphical elements, which are semantically representative of a plurality of verbs, such as “has-owns,” “has-uses,” “is,”“invokes,” and “flow.”

6. The objects of claim 3 wherein structured input areas are provided for the detailed specification of the object.

7. The objects of claim 3 wherein selected portions of the object specification are allowed to be displayed in a plurality of adornments to the shape.

8. The objects of claim 3 wherein there is a plurality of rule, process, and security object shapes.

9. The objects of claim 3 wherein there is a plurality of note, design point, initiative, and issue object shapes.

10. The objects of claim 3 wherein there is a plurality of adornments to identify process and hierarchy object shapes.

11. The objects of claim 3 wherein there is a plurality of user interface object shapes.

12. The objects of claim 3 wherein there is a plurality of domain object shapes.

13. The objects of claim 3 wherein there is a plurality of technology object shapes.

14. The tool and notation of claim 1 wherein there is a plurality of adornments for components that contain their own icon or text.

15. The tool and notation of claim 1 wherein there is an adornment to indicate plural or collections.

16. The tool and notation of claim 1 wherein specification documents are automatically generated from object information.

17. The tool and notation of claim 1 wherein the identity of notation objects and relationships are accessed and managed.

18. The tool and notation of claim 1 wherein output is provided to business and software construction tools, such as Microsoft Excel, Rational Rose or Microsoft Project.

19. A fence, grouping shape to enclose selected shapes comprising a border that can be infinitely, variably-shaped at all points.

20. A subordinate container shape, such as a bracket shape, that is connected to a parent shape or graphical element, comprising:
(a) a variable amount of text and/or graphics
(a) an attachment point that can be positioned anywhere around the parent shape only at predetermined, appropriate points in the vicinity closest to where the user indicates.
